(19) United States
(12) Patent Application Publication
(10) Pub. No.: US 2003/0210516 A1
(43) Pub. Date: Nov. 13, 2003

(54) Isolated mounting plate for optimizing disc drive seek and settle times

(76) Inventors: Frank W. Bernett, Longmont, CO (US); George I. Brent, Boulder, CO (US); Jin-Won Lee, Longmont, CO (US)

Correspondence Address: Shawn B. Dempster, Seagate Technology LLC, Intellectual Property Department - SHK2LG, 1280 Disc Drive, Shakopee, MN, 55379-1863, US

(21) Appl. No.: 09/776,699

(22) Filed: Feb. 5, 2001

Related U.S. Application Data
(60) Provisional application No. 60/181,175, filed on Feb. 9, 2000.

(51) Int. Cl. G06F 1/16; F16M 13/00

(52) U.S. Cl. 361/685; 248/633

(57) ABSTRACT

A device for increasing inertia of a disc drive mounted within a computer system, with the disc drive having a first inertia, is provided. The device comprises a mounting plate securable to the disc drive with the mounting plate having a second inertia. The second inertia of the mounting plate being at least equal to the first inertia of the disc drive. At least one resilient compressible member is securable between the mounting plate and the computer system for isolating movement of the mounting plate relative to the computer system. A method for increasing the inertia of a disc drive mounted within a computer system is also provided.

### RELATED APPLICATIONS

This application claims the benefit of U.S. Provisional Application No. 60/181,175 filed on Feb. 9, 2000.

### FIELD OF THE INVENTION

The present invention relates generally to a mounting plate for a disc drive within a computer system, and more particularly to an isolated mounting plate releasably secured to a disc drive which optimizes the seek arrivals and settle times of the disc drive by isolating the disc drive from the computer system and increasing the inertia of the disc drive.

### BACKGROUND OF THE INVENTION

Generally, the disc drive used as an auxiliary memory device in a computer system includes at least one disk which is rotated at a high speed by a spindle motor, and an actuator arm assembly having an actuator body and a bearing cartridge. The actuator body has at least one arm which rotates in response to a voice coil motor about a pivot point for moving a magnetic head at a distal end of each actuator arm. The magnetic head writes data onto the tracks of the disc and reads the data recorded on the tracks of the disc. The magnetic head moves in proximity to the disc, wherein the magnetic head is influenced by an airflow generated on a surface of the disc as the disc rotates at a high speed to maintain a minute gap between the magnetic head on the actuator arm and the disc.

During use of the disc drive, the operation of the disc drive generates acoustic noises. The acoustic noises of a disc drive mounted in a computer system comes from at least two sources. The first noise source is commonly called “airborne acoustics”. Airborne acoustics are commonly specified as the sound power value by disc drive manufactures and travels from the disc drive through the air to the observer. The second noise source is commonly called structure-borne acoustics. Structure-borne acoustics is typically generated from the disc drive's vibration during idle and seek events.

In an attempt to remedy the acoustic noise problems, isolators were often used when mounting disc drives in computer systems. While these isolators were typically used to isolate the disc drive from vibration coming from the computer system or beyond, isolators were also used to reduce the acoustic noise derived from the disc drive to the computer system during operation, as described above. Since disc drives rotate upon torque from the actuator during a seek event and the isolators act basically as “springs”, the isolators “wind up” during a seek event and then unwind when the actuator is trying to settle on track. Thus, a major problem was created with the additional spring motion in the disc drive during seek and settling events.

As the isolators “wind up” during a seek and then unwind when the actuator is trying to settle on track, too much motion is created for the servo system to fully track thereby causing an offtrack condition to occur. The offtrack condition causes delays in settling or causes the magnetic heads to leave a track just after settling occurred. As a result of the performance degradation, the use of isolators have been virtually eliminated thereby increasing acoustic problems with the disc drive.

A need therefore exists in the art for an isolated mounting plate releasably secured to a disc drive which optimizes the seek arrivals and settle times of the disc drive by isolating the disc drive from the computer system and increasing the inertia of the disc drive. It is desirable that this be achieved, moreover, without compromising the performance of the disc drive and the mounting of the disc drive within the computer system. The present invention solves these problems and offers other advantages over the prior art.

### SUMMARY OF THE INVENTION

The present invention relates to a device for increasing inertia of a disc drive mounted within a computer system with the disc drive having a first inertia. The device comprises a mounting plate securable to the disc drive with the mounting plate having a second inertia. The second inertia of the mounting plate being at least equal to the first inertia of the disc drive. At least one resilient compressible member is securable between the mounting plate and the computer system for isolating movement of the mounting plate relative to the computer system. A method for increasing inertia of a disc drive mounted within a computer system is also provided.

### BRIEF DESCRIPTION OF THE DRAWINGS

FIG. 1 shows a perspective view of a disc drive secured to an isolated mounting plate of the present invention.

FIG. 2 shows a side view of the disc drive secured to the isolated mounting plate of the present invention.

FIG. 3 shows a top view of the disc drive secured to the isolated mounting plate of the present invention.

FIG. 4 shows a graph of the write retry rate versus the inertia of the disc drive secured to the isolated mounting plate of the present invention.

### DETAILED DESCRIPTION

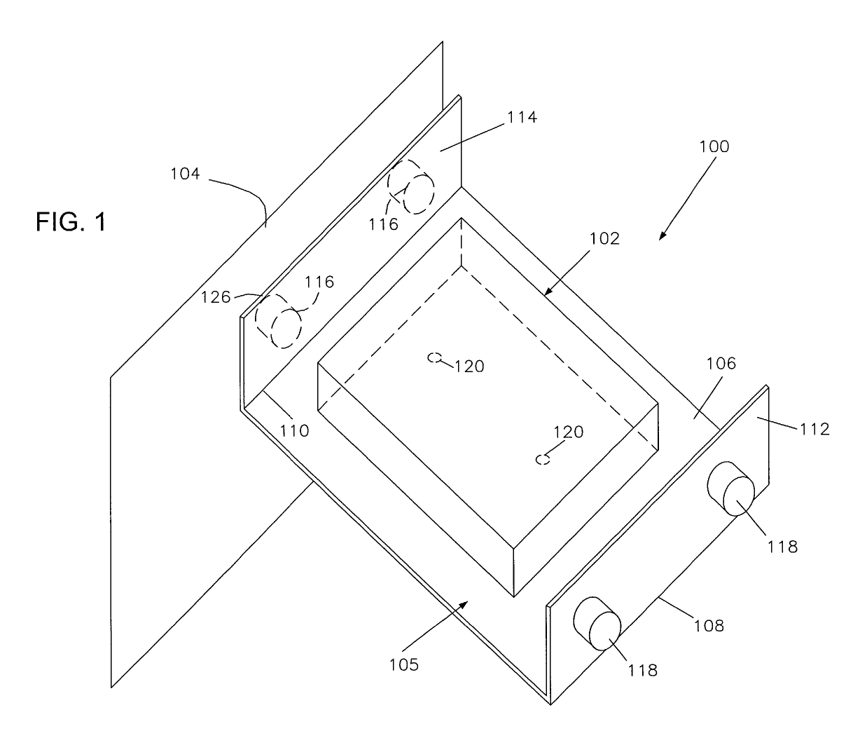

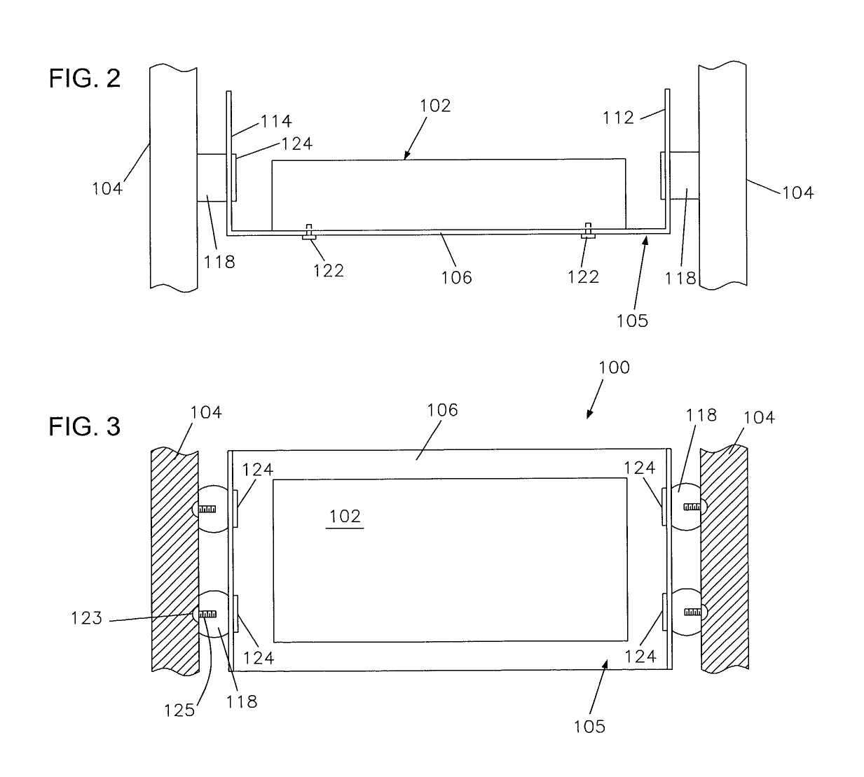

As illustrated in FIG. 1, FIG. 2, and FIG. 3, the present invention is a device 100 for increasing the moment of inertia of a disc drive 102 within a computer system 104. The use of the device 100, with the disc drive 102 secured thereon, optimizes the seek arrivals and settle times of the disc drive 102 by isolating the disc drive 102 from the computer system 104 and increasing the moment of inertia of the disc drive 102.

The device 100 of the present invention includes a mounting plate 105 having a base 106. The base 106 includes a first side edge 108 and a second side edge 110 substantially opposite the first side edge 108. The mounting plate 105 further has a first side wall 112 secured to the first side edge 108 and substantially perpendicular to the base 106 and a second side wall 114 secured to the second side edge 110 and substantially perpendicular to the base 106. While the first side wall 112 and the second side wall 114 are described as being secured to the base 106, it is within the scope of the present invention to form the base 106, the first side wall 112, and the second side wall 114 from a single sheet of material with the first side wall 112 and the second side wall 114 bent or otherwise manipulated into a substantially perpendicular position relative to the base 106.

The first side wall 112 and the second side wall 114 each include at least one mounting aperture 116 formed therethrough. A bolt, screw, or other fastening mechanism (not shown) extends through each mounting aperture 116 to secure the mounting plate 105 of the present invention to the computer system 104. A resilient, compressible isolator 118, as discussed further below, will be positioned between the first side wall 112 and the computer system 104 and the second side wall 114 and the computer system 104 to absorb any movement of the disc drive 102 during seek events.

Preferably, the base 106, the first side wall 112, and the second side wall 114 of the mounting plate 105 are formed from a steel or other metal material and have a thickness between approximately one (1 mm) millimeter and two (2 mm) millimeters. It is within the scope of the present invention, however, to form the base 106, the first side wall 112, and the second side wall 114 from another type of material including, but not limited to, plastic, ceramic, etc. Furthermore, as discussed in further detail below, the inertia of the mounting plate 105 is preferably at least twice the inertia of the disc drive 102 resulting in at least doubling the moment of inertia of the disc drive 102 during the seek events.

The base 106 of the mounting plate 105 includes a plurality of base apertures 120 formed therethrough. As discussed above, the disc drive 102 is secured to the base 106 of the mounting plate 105 by extending screws 122 or the like through the base apertures 120 and into disc drive apertures (not shown) formed in the disc drive 102.

The device 100 of the present invention further includes the plurality of resilient, compressible isolators 118 positioned between the mounting apertures 116 and the computer system 104. The isolators 118 absorb movement of the mounting plate 105 and the disc drive 102 due to the moment of inertia of the disc drive 102 during seek events. Preferably, the isolators 118 are formed from a resilient, compressible material such as rubber, plastic, or the like.

While the isolators 118 can be secured by any appropriate means, in one embodiment, the isolator 118 can be pre-bonded to the first side wall 112 and the second side wall 114. Then, screws 123 can be extended through the computer system 104 into a threaded aperture 125 in the isolator 118. The threaded aperture 125 can be a threaded metal fitting within the isolator 118 for receiving the screw 123.

In another embodiment, the isolators 118 have a grommet-like portion 124 on each end which can be pushed into the mounting apertures 116 of the first side wall 112 and the second side wall 114 and the computer system apertures 126 in the computer system 104. The number and placement of the isolators 118 is a function of the shock and vibration forces expected from the disc drive 102 and the computer system 104. In an embodiment of the present invention, two isolators 118 are used on the first side wall 112 and two isolators 118 are used on the second side wall 114.

The amount of motion caused by a seek event in the disc drive 102 can be reduced by increasing the inertia of the disc drive 102. While it is possible to add inertia directly to the disc drive 102, the addition of inertia is typically limited by disc drive size constraints of the desired form factor.

The mounting plate 105 of the present invention is sized and shaped to increase the moment of inertia of the disc drive 102. Preferably, the mounting plate 105 at least doubles the inertia of the disc drive 102. Therefore, the inertia of the isolated mounting plate 100 is at least approximately equal to the inertia of the disc drive 102 thereby at least doubling the moment of inertia of the disc drive 102.

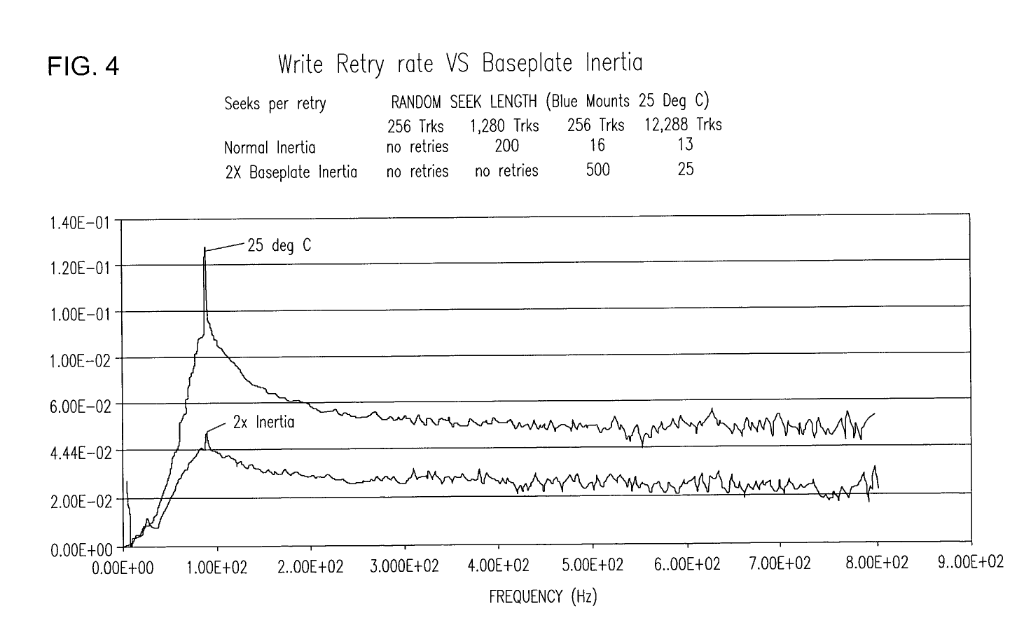

As illustrated in FIG. 4, the graph illustrates the reduction in the seek event problems while using the device 100 of the present invention, as well as the improved write retry rates associated with doubling the inertia of the disc drive 102 secured to the mounting plate 105. The write retry rate is an indication of seek and settle problems associated with any movement of the disc drive 102 during seek and settle events. The numbers indicate how many seeks are completed successfully without the need for a retry. The lower the number the worse the performance degradation. As the seek lengths get longer, the problem gets greater. The increase in inertia makes a disc drive 102 have less retries while still benefiting from the effect of the isolators 118.

The present invention can be summarized in reference to FIG. 1, FIG. 2, and FIG. 3, which are views of the preferred embodiment device 100 for increasing inertia of a disc drive 102 mounted within a computer system 104, with the disc drive 102 having a first inertia. The device 100 comprises a mounting plate 105 securable to the disc drive 102. The mounting plate 105 has a second inertia with the second inertia of the mounting plate 105 being at least equal to the first inertia of the disc drive 105. At least one resilient compressible member 118 is securable between the mounting plate 105 and the computer system 104 for isolating movement of the mounting plate 105 relative to the computer system 104.

In an embodiment of the present invention, the mounting plate 105 includes a base 106, a first side wall 112 connected to the base 106, and a second side wall 114 connected to the base 106 substantially opposite the first side wall 112 with the first side wall 112 and the second side wall 114 being securable to the computer system 104. Furthermore, preferably, the first side wall 112 and the second side wall 114 each have at least one mounting aperture 116 formed therethrough and the computer system 104 has at least one system aperture 126 formed therethrough. Each mounting aperture 116 is alignable with each system aperture 126 with a fastening mechanism 124 receivable within each mounting aperture 116 and securable within each corresponding system aperture 126 of the computer system 104.

In an embodiment of the present invention, a resilient compressible member 118 is positioned between the first side wall 112 and the second side wall 114 with each resilient compressible member 118 being aligned with one of the mounting apertures 116 and a corresponding system aperture 126.

In another embodiment of the present invention, each resilient compressible member 118 has grommet-like portions 124 on each end with one end being insertable into one of the mounting apertures 116 and the other end being insertable into one of the corresponding system apertures 126.

Preferably, each resilient compressible member 118 is constructed from a material selected from the group consisting of rubber and plastic.

The present invention further includes a method for increasing inertia of a disc drive 102 mounted within a computer system 104 with the disc drive 102 having a first inertia. The method comprises steps of providing a mounting plate 105 having a second inertia at least equal to the first inertia of the disc drive 102, securing the disc drive 102 to the mounting plate 105, and providing at least one resilient member 118 between the mounting plate 105 and the computer system 104.

In an embodiment of the present invention, the method further comprises steps of securing a first side wall 112 to the mounting plate 105, securing a second side wall 114 to the mounting plate 105, securing the disc drive 102 between the first side wall 112 and the second side wall 114, and securing the first side wall 112 and the second side wall 114 to the computer system 104.

In another embodiment of the present invention, the method further comprises steps of positioning at least one resilient member 118 between the first side wall 112 and the computer system 104 and positioning at least one resilient member 118 between the second side 114 wall and the computer system 104.

All of the structures described above will be understood to one of ordinary skill in the art, and would enable the practice of the present invention without undue experimentation. It is to be understood that even though numerous characteristics and advantages of various embodiments of the present invention have been set forth in the foregoing description, together with details of the structure and function of various embodiments of the invention, this disclosure is illustrative only. Changes may be made in the details, especially in matters of structure and arrangement of parts within the principles of the present invention to the full extent indicated by the broad general meaning of the terms in which the appended claims are expressed. For example, the particular elements may vary depending on the particular application for the present system while maintaining substantially the same functionality, without departing from the scope and spirit of the present invention. In addition, although the preferred embodiments described herein are largely directed to disc drives, it will be appreciated by those skilled in the art that the teachings of the present invention can be applied to other data handling systems such as wireless communication without departing from the scope and spirit of the present invention.

What is claimed is:

1. A device for increasing inertia of a disc drive mounted within a computer system, the disc drive having a first inertia, the device comprising:
(a) a mounting plate securable to the disc drive, the mounting plate having a second inertia, the second inertia of the mounting plate being at least equal to the first inertia of the disc drive; and
(b) at least one resilient compressible member securable between the mounting plate and the computer system for isolating movement of the mounting plate relative to the computer system.

2. The device of claim 1 wherein the mounting plate includes a base, a first side wall connected to the base, and a second side wall connected to the base substantially opposite the first side wall, the first side wall and the second side wall securable to the computer system.

3. The device of claim 2 wherein the first side wall and the second side wall each have at least one mounting aperture formed therethrough and the computer system has at least one system aperture formed therethrough, each mounting aperture alignable with each system aperture, and further comprising a fastening mechanism receivable within each mounting aperture and securable within each corresponding system aperture of the computer system.

4. The device of claim 3 wherein a resilient member is positioned between the first side wall and the second side wall, each resilient member being aligned with one of the mounting apertures and a corresponding system aperture.

5. The device of claim 3 wherein each resilient compressible member has a first end having a first grommet-like portion and a second end having a second grommet-like portion, the first grommet-like portion being insertable into one of the mounting apertures and the second grommet-like portion being insertable into one of the corresponding system apertures.

6. The device of claim 1 wherein each resilient compressible member is constructed from a material selected from the group consisting of rubber and plastic.

7. A method of increasing inertia of a disc drive of claim 1 mounted in a computer system, the disc drive having a first inertia, comprising steps of:
(a) securing a mounting plate to the disc drive, the mounting plate having a second inertia equal to or greater than the disc drive; and
(b) isolating the combined mounting plate and disc drive.

8. A method for increasing inertia of a disc drive mounted within a computer system, the disc drive having a first inertia, comprising steps of:
(a) providing a mounting plate, the mounting plate having a second inertia at least equal to the first inertia of the disc drive;
(b) securing the disc drive to the mounting plate; and
(c) providing at least one resilient member between the mounting plate and the computer system.

9. The method of claim 8 and further comprising steps of:
(d) securing a first side wall to the mounting plate;
(e) securing a second side wall to the mounting plate;
(f) securing the disc drive between the first side wall and the second side wall; and
(g) securing the first side wall and the second side wall to the computer system.

10. The method of claim 9 and further comprising steps of:
(h) positioning at least one resilient member between the first side wall and the computer system; and
(i) positioning at least one resilient member between the second side wall and the computer system.

11. A device for increasing inertia of a disc drive mounted within a computer system constructed from the method of claim 8, the device comprising:
a mounting plate having a second inertia at least equal to the first inertia of the disc drive, the disc drive securable to the mounting plate; and
at least one resilient member positioned between the mounting plate and the computer system.

12. An isolation device for improving seek and settle times for a disc drive in a computer system, the disc drive having a predetermined moment of inertia, the isolation device comprising:
means secured to the disc drive for increasing the moment of inertia of the disc drive by a factor of at least two;
at least one isolator between the disc drive and the computer system for isolating movement of the disc drive relative to the computer system.

13. The isolation device of claim 12, wherein the disc drive has a first inertia, further wherein the means includes a mounting plate having a second inertia, the second inertia of the mounting plate being equal to or greater than the first inertia of the disc drive.

14. The isolation device of claim 13 wherein the mounting plate includes a base, a first side wall connected to the base, and a second side wall connected to the base substantially opposite the first side wall, the first side wall and the second side wall securable to the computer system.

15. The isolation device of claim 13 wherein the isolator is a resilient compressible member positioned between the means and the computer system.

16. The isolation device of claim 15 wherein each resilient compressible member is constructed from a material selected from the group consisting of rubber and plastic.

17. A method for improving seek and settle times for a disc drive in a computer system, the disc drive having a predetermined inertia, comprising steps of:
(a) at least doubling the inertia of the disc drive; and
(b) isolating movement of the disc drive relative to the computer system.

18. The method of claim 17 wherein the disc drive has a first inertia, and further comprising steps of:
(c) providing a mounting plate having a second inertia equal to or greater than the first inertia of the disc drive;
(d) securing the disc drive to the mounting plate; and
(e) securing the mounting plate to the computer system.

19. The method of claim 18 and further comprising steps of:
(f) providing at least one isolator; and
(g) positioning the isolator between the mounting plate and the computer system.

20. The method of claim 19 wherein the isolator is a compressible, resilient member constructed from a material selected from the group consisting of rubber and plastic.
